(19) United States
(12) Patent Application Publication
(10) Pub. No.: US 2014/0380489 A1
(43) Pub. Date: Dec. 25, 2014

(54) SYSTEMS AND METHODS FOR DATA ANONYMIZATION

(71) Applicants: Hakim Hacid, Paris (FR); Laura Maag, Paris (FR)

(72) Inventors: Hakim Hacid, Paris (FR); Laura Maag, Paris (FR)

(73) Assignee: ALCATEL-LUCENT BELL LABS FRANCE, Paris (FR)

(21) Appl. No.: 13/922,902

(22) Filed: Jun. 20, 2013

(51) Int. Cl. G06F 21/60

(52) U.S. Cl. CPC G06F 21/60
USPC 726/26

(57) ABSTRACT

A system and method for dynamic anonymization of a dataset includes decomposing, at at least one processor, the dataset into a plurality of subsets and applying an anonymization strategy on each subset of the plurality of subsets. The system and method further includes aggregating, at the at least one processor, the individually anonymized subsets to provide an anonymized dataset.

### FIELD OF THE INVENTION

The present invention relates to data analytics.

### BACKGROUND OF THE INVENTION

Databases of data (e.g. databases containing generally statistical data regarding individuals, companies, businesses, etc.) generated by companies, users on the World Wide Web, devices, and the like may be analyzed and used to improve business decisions and services. For example, data analytics may allow a company to better react to hotline calls, to prevent churn in the context of an operator with subscribers, to better target advertising campaign in a marketing context, to price services, or to provide other similar benefits. However, data owners are not the only ones interested in the value hidden in their data. Rather, others (often malicious users) may attempt to use the data and the hidden value for many different purposes. Therefore, anonymization strategies are often applied to datasets, as a whole, to hide sensitive information in the data to make it difficult for other external users to find the sensitive information.

### SUMMARY

According to an embodiment, a dynamic anonymization system includes at least one communication interface adapted to import at least one dataset into the dynamic anonymization system and at least one processor. The at least one processor is adapted to decompose the at least one dataset into a plurality of subsets, apply an anonymization strategy on each subset of the plurality of subsets, and aggregate the individually anonymized subsets to provide an anonymized dataset. The communication interface may be adapted to output the anonymized dataset.

According to an embodiment, the dynamic anonymization system further includes a data decomposer executing on the at least one processor. The data decomposer is adapted to divide the at least one dataset into the plurality of subsets. The dynamic anonymization system may also include a local anonymizer executing on the at least one processor and adapted to apply the anonymization strategy on each subset of the plurality of subsets. The dynamic anonymization system may also include an anonymization composer executing on the at least one processor and adapted to aggregate the individually anonymized subsets to provide the anonymized dataset.

According to an embodiment, the dynamic anonymization system may also include a coordinator that ensures proper communication between the data decomposer, the local anonymizer and the anonymization composer.

According to an embodiment, the coordinator may monitor operation of the decomposer, the local anonymizer and the anonymization composer and may ensure that critical information is not released in the anonymized dataset.

According to an embodiment, the dynamic anonymization system may also include a feature processor adapted to input the at least one dataset and at least one analytical objective to provide values to objects in the dataset for the data decomposer.

According to an embodiment, the at least one dataset includes a set of information to be hidden and the feature processor may provide values for objects in the set of information to be hidden.

According to an embodiment, the communication interface may include a plurality of data loaders adapted to read datasets of different formats.

According to an embodiment, the communication interface may include a data server executing security protocol before outputting the anonymized dataset to ensure that the anonymized dataset is only accessed by authorized entities.

According to an embodiment, the communication interface is adapted to input analysis results based on the anonymized dataset and the at least one processor is adapted to decode the analysis results. The communication interface may be adapted to output the decoded analysis results.

According to an embodiment, a computerized method for providing an anonymized dataset includes decomposing, at at least one processor, a dataset into a plurality of subsets. The method further includes individually anonymizing, at the at least one processor, each subset of the plurality of subsets and aggregating, at the at least one processor, the individually anonymized subsets to provide the anonymized dataset.

According to an embodiment, decomposing, at the at least one processor, the dataset into the plurality of subsets may include dividing the dataset into the plurality of subsets based on a time dimension.

According to an embodiment, each subset of the plurality of subsets may be an independent interval that does not intersect other subsets of the plurality of subsets.

According to an embodiment, at least one subset of the plurality of subsets may be a cross interval that intersects another subset of the plurality of subsets.

According to an embodiment, the computerized method may also comprise providing, at the at least one processor, values to objects in the dataset based at least on an analytical objective before decomposing the dataset into the plurality of subsets.

According to an embodiment, the values provided to the objects in the dataset may be based on a set of information to be hidden.

According to an embodiment, a non-transitory, tangible computer-readable medium stores instructions adapted to be executed by a computer processor for providing an anonymized dataset by performing a method comprising the steps of decomposing, at at least one processor, the dataset into a plurality of subsets, individually anonymizing, at the at least one processor, each subset of the plurality of subsets, and aggregating, at the at least one processor, the individually anonymized subsets to provide the anonymized dataset.

According to an embodiment, decomposing, at the at least one processor, the dataset into the plurality of subsets may include dividing the dataset into the plurality of subsets based on a time dimension.

According to an embodiment, each subset of the plurality of subsets may be an independent interval that does not intersect other subsets of the plurality of subsets.

According to an embodiment, at least one subset of the plurality of subsets may be a cross interval that intersects another subset of the plurality of subsets.

According to an embodiment, the method may additionally comprise providing, at the at least one processor, values to objects in the dataset based at least on an analytical objective before decomposing the dataset into the plurality of subsets.

These and other embodiments will become apparent in light of the following detailed description herein, with reference to the accompanying drawings.

### BRIEF DESCRIPTION OF THE DRAWINGS

FIG. 1 is a schematic diagram of a dynamic anonymization system according to an embodiment;

FIG. 2 is a schematic diagram of an embodiment for anonymizing a dataset in the dynamic anonymization system of FIG. 1;

FIG. 3 is a graphical representation of an embodiment for anonymizing a dataset through the dynamic anonymization system of FIG. 1; and

FIG. 4 is a schematic diagram of an embodiment of a data analytics ecosystem including the dynamic anonymization system of FIG. 1.

### DETAILED DESCRIPTION

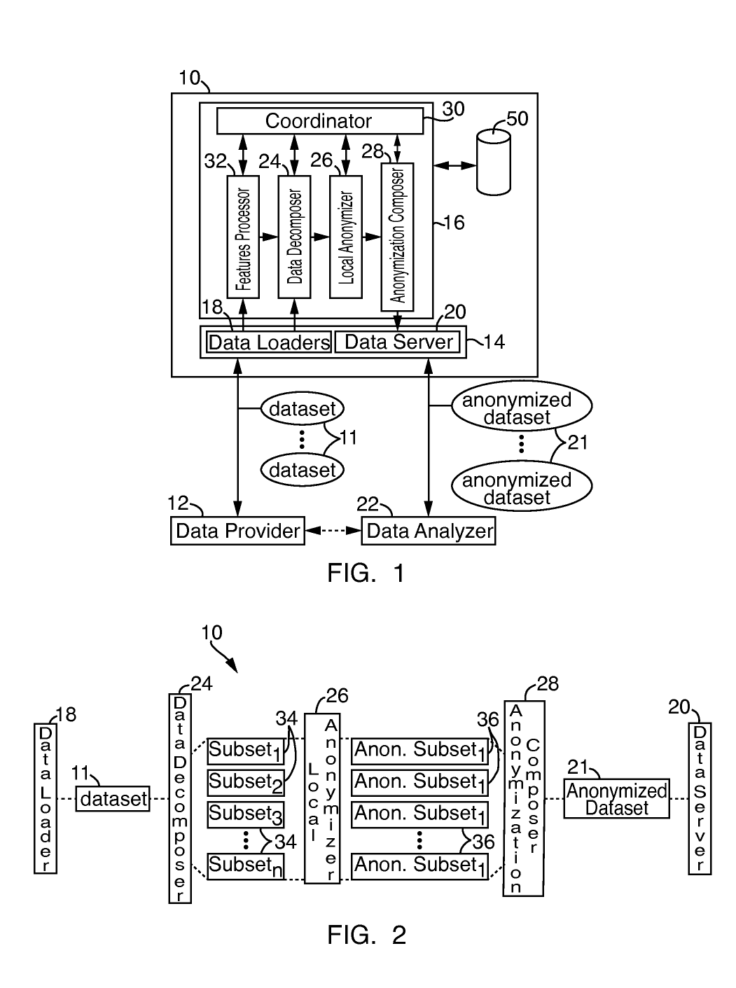

Referring to FIG. 1, a dynamic anonymization system 10 for anonymizing datasets 11 from one or more data providers 12 is shown. The dynamic anonymization system 10 includes at least one communication interface 14 and at least one processor 16.

The at least one communication interface 14 is adapted to import at least one dataset 11 from the one or more data providers 12 into the dynamic anonymization system 10. The at least one communication interface 14 may include one or more data loaders 18 comprising adapters allowing the at least one communication interface 14 to read and import datasets 11 in different formats. For example, the one or more data loaders 18 may enable the communication interface 14 to import relational databases, flat files, spreadsheets, XML files, or any other similar dataset formats as should be understood by those skilled in the art. The at least one communication interface 14 may also include a data server 20 adapted to output anonymized datasets 21 to one or more data analyzers 22. The data server may include an authentication, authorization, and accounting module to ensure that access to the anonymized datasets 21 is only granted to data analyzers 22 and other entities that have authorization. For example, the authentication, authorization, and accounting module may implement a rights management process, password protection and/or other security protocol as should be understood by those skilled in the art.

The at least one processor 16 is adapted to execute a data decomposer 24, a local anonymizer 26 and an anonymization composer 28 to dynamically anonymize the at least one dataset 11 imported through the at least one communication interface 14 and the data loaders 18. The at least one processor 16 may also be adapted to execute a coordinator 30 and a feature processor 32 to optimize the dynamic anonymization of the dataset 11 as will be discussed in greater detail below.

Referring to FIG. 2, the data decomposer 24 divides the at least one dataset 11 into a plurality of subsets 34 based on a decomposition parameter. The data decomposer 24 may divide the dataset 11 into n subsets 34 including independent subsets where the data in each subset 34 is independent of the data in each of the other subsets 34, cross subsets that include intersections between the data in the subsets 34 (e.g. a particular subset 34 may include a small portion of data that is also included in an adjacent subset 34), or a combination of independent subsets and cross subsets. The decomposition parameter used by the data decomposer 24 for dividing the dataset 11 into the plurality of subsets 34 may be, for example, a time interval, a number of data entries, a density of data defined as a number of data entries within the subset as well as the amount and type of data included with each data entry, or any other similar parameter that may be used to divide the dataset 11. For example, the data decomposer 24 may select the division of the independent subsets and/or cross subsets to provide each subset 34 with approximately the same density of data within each subset 34. Dividing the dataset 11 based on density of data, rather than the number of data entries alone, masks the decomposition by providing a non-uniform decomposition. This non-uniform decomposition may make it more difficult for potential attackers to learn sensitive information when trying to de-anonymize the anonymized dataset 21, as will be discussed in greater detail below. Additionally, including cross subsets within the plurality of subsets 34 further masks the decomposition since potential attackers will have difficulty determining the overlapping data within particular subsets 34 due to the data intersections. Using the decomposition parameter, the data decomposer 24 converts the dataset 11 into a plurality of subsets 34, which, if combined, reconstruct the whole initial dataset 11.

In embodiments where the decomposition parameter is a fixed parameter, such as a fixed time interval, a fixed number of data entries or the like, additional masking may be added by the anonymization composer 28 to mask the decomposition parameter, as will be discussed below.

The local anonymizer 26 applies an anonymization strategy individually on each subset 34 obtained from the data decomposer 24 to produce a plurality of individually anonymized subsets 36. The anonymization strategy locally applied to each individual subset 34 may be any anonymization strategy known in the art that would normally be applied to a set of data as a whole.

Different anonymization strategies have been developed for different kinds of data representations, all of which may be implemented by the local anonymizer 26. For example, specific anonymization strategies have been developed for tabular data, while more complex anonymization strategies have been developed for graphical data, both of which may be implemented by the local anonymizer 26, depending on the format of the dataset 11. These known anonymization strategies attempt to find a compromise between privacy and utility of data. In general, anonymization strategies rely on two main principles, k-anonymity and I-diversity. K-anonymity provides a definition for how many data entries will match a given query for an anonymized dataset. Specifically, An anonymized dataset is k-anonymous if there are at least k data entries that match a given query performed on the anonymized dataset. In other words, a dataset is k-anonymous when, for any given query, a data entry is indistinguishable from k−1 other data entries. However, an anonymized dataset being k-anonymous does not necessarily protect the privacy of particular data entries since there may be structural similarities between the k data entries returned for a given query. Thus, even if a particular data entry cannot be identified, if the k similar nodes all have a sensitive attribute in common, then the privacy of the k nodes is not protected. For example, if a query for a particular name in an anonymized dataset returns 10 data entries, the particular data entry of interest cannot be identified. However, if all 10 data entries returned by the query have a common attribute (such as a particular disease in the case of a medical database), it is possible to determine that the particular data entry of interest includes the disease and, therefore, privacy is broken. L-diversity provides a definition for the distribution of structural similarities between data entries in the anonymized dataset.

The local anonymizer 26 applies any known anonymization strategy to each subset 34, individually, to provide the plurality of anonymized subsets 36, each anonymized subset 36 having k-anonymity and I-diversity as should be understood by those skilled in the art. In some embodiments, the local anonymizer 26 may apply the same anonymization strategy to each subset 34, while in other embodiments, the local anonymizer 26 may apply different anonymization strategies to one or more of the subsets 34.

The anonymization composer 28 aggregates all of the locally anonymized subsets 36 provided by the local anonymizer 26 into the single anonymized dataset 21. This recombination performed by the anonymization composer 28 masks the decomposition parameter used by the data decomposer 24 to divide the dataset 11 into the plurality of subsets 34 by ensuring that only the single anonymized dataset 21 is output from the dynamic anonymization system 10 for the input dataset 11. As discussed above, in embodiments where the decomposition parameter is a substantially constant density of data, the inclusion of cross subsets within the plurality of subsets 34, itself, masks the decomposition parameter by including overlapping data within particular subsets 34 and, therefore, within the anonymized subsets 36. This overlapping anonymized data within the anonymized subsets 36 makes it difficult for potential attackers to decompose the anonymized dataset 21. In embodiments where the decomposition parameter is a fixed parameter, such as a fixed time interval or a fixed number of data entries, the anonymization composer 28 may apply a distortion function during aggregation of the plurality of anonymized subsets 36 to mask the decomposition parameter. For example, for a fixed time interval decomposition parameter, the anonymization composer 28 may apply a time distortion function so that the time corresponding to a particular anonymized subset 36 does not have any direct correspondence to the time corresponding to the same time interval in the original dataset 11. In some embodiments, where the decomposition parameter is density of data, the density of data for each subset 34 may, itself, be varied during decomposition of the dataset 11 so that, when the anonymization composer 28 aggregates anonymized subsets 36, each anonymized subset 36 has a different density of data value for the decomposition parameter. Thus, if potential attackers are able to discover the decomposition parameter corresponding to one anonymized subset 36, the discovery will not necessarily lead to the discovery of the decomposition parameters for the remaining anonymized subsets 36 aggregated into the anonymized dataset 21. Thus, the aggregation of the anonymized subsets 36 into the anonymized dataset 21 by the anonymization composer 28 includes measures that inhibit potential attackers from discovering the local anonymization of the anonymized subsets 36.

By applying the anonymization strategy locally to the individual subsets 34, rather than to the entire dataset 11 as a whole, the anonymization of the anonymized dataset 21 becomes more difficult to break down by potential attackers because the masking of the decomposition parameter adds another dynamic dimension to the anonymized dataset 21. In particular, the decomposition, local anonymization and recombination provided by the dynamic anonymization system 10 eliminates regular, unique patterns, that might be used to de-anonymize the data by potential attackers, from propagating throughout the anonymized dataset 21. Thus, the dynamic anonymization system 10 advantageously provides improved dataset anonymization as compared to anonymization of the initial dataset as a whole in a static manner.

Referring back to FIG. 1, as discussed above, the dynamic anonymization system 10 may include the feature processor 32 and the coordinator 30 to aid in the dynamic anonymization of the dataset 11. The feature processor 32 may receive the at least one dataset 11 from the one or more data loaders 18 before the dataset 11 is provided to the data decomposer 24. The one or more data loaders 18 may also provide the feature processor 32 with an analytical objective and a set of data entries, e.g. information, within the dataset 11 that is to be hidden. The analytical objective and the set of data entries to be hidden may be provided to the one or more data loaders 18 by the data provider 12. The analytical objective may be, for example, to determine influence through interconnectivity and centrality of data entries, to evaluate density for communities, or any other analytical objective. The feature processor 32 provides values associated with information objects in each data entry of the dataset 11 based on the analytical objective and the set of information to be hidden. These values may, for example, indicate which information objects are to be hidden, which information objects affect the analytical objective and/or to what extent, or may provide any similar information for processing the dataset 11. The data decomposer 24 and/or local anonymizer 26 may then use these values when dividing the dataset 11 into the plurality of subsets 34 and when individually anonymizing the subsets 34, respectively, to provide for optimal utilization of the anonymized dataset 21.

The coordinator 30 may be implemented in the dynamic anonymization system 10 to coordinates proper communication and interaction between the other components of the dynamic anonymization system 10 such as the data decomposer 24, the local anonymizer 26, the anonymization composer 28 and the feature processor 32. For example, the coordinator 30 may ensure that the values generated by the feature processor 32 are provided to the data decomposer 24 and local anonymizer 26 for processing, as discussed above. Similarly, the coordinator 30 may provide the decomposition parameter used by the data decomposer 24 and/or information on the subset division, such as whether cross subsets were included, to the anonymization composer 28 so that the anonymization composer 28 may provide additional masking to the decomposition parameter, if necessary. By coordinating interactions between the components of the dynamic anonymization system 10, the coordinator 30 is able to ensure that the anonymization provided by the dynamic anonymization system 10 does not decrease an expected quality of analysis to be performed on the anonymized dataset 21 and ensures that critical person information in the dataset 11 is not released in the anonymized dataset 21. Thus, the anonymized dataset 21 generated by the dynamic anonymization system 10 provides high analytical quality while hiding sensitive, specified, data regarding individuals, businesses or the like in the initial dataset 11.

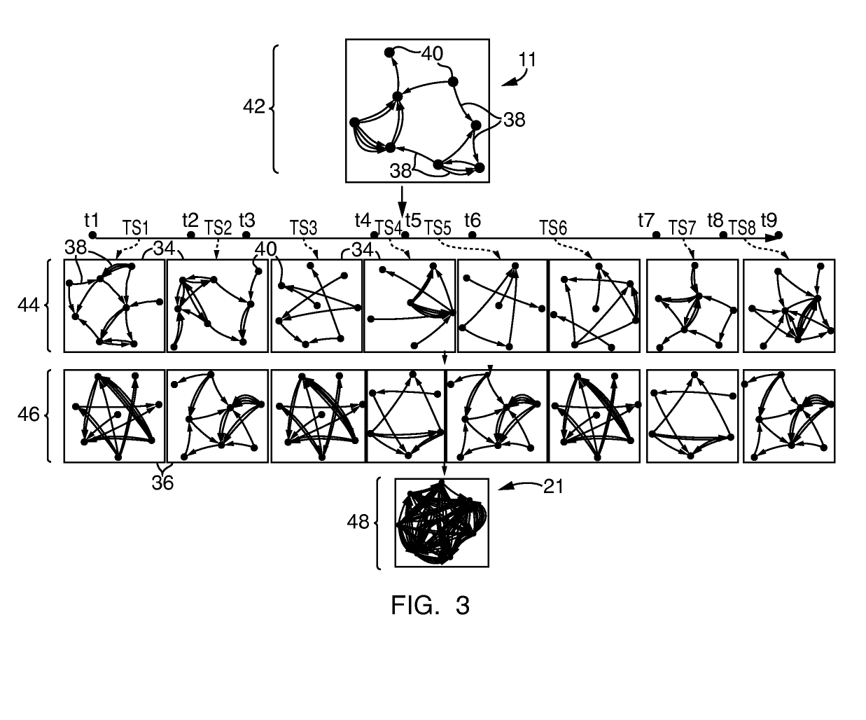

Referring to FIG. 3, an exemplary embodiment of anonymization of a dataset 11 by the dynamic anonymization system 10, shown in FIG. 1, is shown. In this exemplary embodiment, the dataset 11 may be graphical call data from a communication network representing calls 38 between nodes 40 (e.g. network subscribers) in the communication network. Analysis of the dataset 11 may provide various benefits to the data provider 12, shown in FIG. 1. For example, the analysis may allow the data provider 12 to better react to hotline calls, to prevent churn in the context of an operator with subscribers, to better target advertising campaigns, to price services, or to provide other similar benefits. The dynamic anonymization system 10, shown in FIG. 1, may, therefore, advantageously be implemented to provide access to the data within the dataset 11 for statistical analysis without allowing information about specific nodes 40 within the dataset 11 to be discovered.

At 42, the dataset 11 is loaded into the dynamic anonymization system 10, shown in FIG. 1, by one of the data loaders 18, shown in FIG. 1. At 44, the data decomposer 24, shown in FIG. 1, divides the dataset 11 into the plurality of subsets 34 by maintaining the density of data for each subset to be substantially the same. In this exemplary embodiment, the density may include the amount of nodes 40 (e.g. users or subscribes) combined with the amount of interactions between the nodes (e.g. calls 38). As seen in FIG. 3, dividing the dataset 11 into subsets 34 having substantially the same density of data provides for a dynamic temporal decomposition where the time intervals TS1, TS2, TS3, TS4, TS5, TS6, TS7 and TS8 of data included in the subsets 34 vary in duration. The subsets 34 may include both independent subsets and cross subsets as discussed above.

At 46, the local anonymizer 26, shown in FIG. 1, individually anonymizes each subset 34 to provide the anonymized subsets 36. As discussed above, the local anonymization provided by the local anonymizer 26, shown in FIG. 1, may by any known anonymization strategy, such as those relying on the principles of k-anonymity and I-diversity.

At 48, the anonymization composer 28, shown in FIG. 1, aggregates the locally anonymized subsets 36 provided by the local anonymizer 26, shown in FIG. 1, into the single anonymized dataset 21 as discussed above. The anonymization composer 28, shown in FIG. 1, may then send the anonymized dataset 21 to the data server 20, shown in FIG. 1, so that the anonymized dataset 21 may be made available to one or more data analyzers 22, shown in FIG. 1. The anonymized dataset 21 makes the statistical data in the dataset 11 available to the analyzers 22, shown in FIG. 1, without allowing information about specific nodes 40 within the dataset 11 to be discovered.

By operating on the subsets 34 with non-uniform decompositions (with respect to the time dimension), the dynamic anonymization system 10, shown in FIG. 1, provides additional complexity to inhibit potential attackers from obtaining insights regarding the decomposition of the dataset 11. Accordingly, the decomposition of the dataset 11, itself, provides an additional anonymization parameter to mask the information within the dataset 11.

The dynamic anonymization system 10 has the necessary electronics, software, memory, storage, databases, firmware, logic/state machines, microprocessors, communication links, displays or other visual or audio user interfaces, printing devices, and any other input/output interfaces to perform the functions described herein and/or to achieve the results described herein. For example, the dynamic anonymization system 10 may include the at least one processor 16, discussed above, system memory, including random access memory (RAM) and read-only memory (ROM), an input/output controller, and one or more data storage structures 50, shown in FIG. 1. All of these latter elements are in communication with the at least one processor to facilitate the operation of the dynamic anonymization system 10 as discussed above. Suitable computer program code may be provided for executing numerous functions, including those discussed above in connection with the dynamic anonymization system 10 and its components. The computer program code may also include program elements such as an operating system, a database management system and “device drivers” that allow the dynamic anonymization system 10 to interface with computer peripheral devices (e.g., a video display, a keyboard, a computer mouse, etc.).

The at least one processor of the dynamic anonymization system 10 may include one or more conventional microprocessors and one or more supplementary co-processors such as math co-processors or the like. The processor may be in communication with the communication interface 14, which may include multiple communication channels for simultaneous communication with the one or more data providers 12 and one or more data analyzers 22, which may each include other processors, servers or operators. Devices, elements and components in communication with each other need not be continually transmitting to each other. On the contrary, such devices need transmit to each other as necessary, may actually refrain from exchanging data most of the time, and may require several steps to be performed to establish a communication link between the devices.

The data storage structures discussed herein, including the data storage structure 50, shown in FIG. 1, may comprise an appropriate combination of magnetic, optical and/or semiconductor memory, and may include, for example, RAM, ROM, flash drive, an optical disc such as a compact disc and/or a hard disk or drive. The data storage structures may store, for example, information required by the dynamic anonymization system 10 and/or one or more programs (e.g., computer program code and/or a computer program product) adapted to direct the dynamic anonymization system 10 to provide anonymized datasets 21 according to the various embodiments discussed herein. The programs may be stored, for example, in a compressed, an uncompiled and/or an encrypted format, and may include computer program code. The instructions of the computer program code may be read into a main memory of a processor from a computer-readable medium. While execution of sequences of instructions in the program causes the processor to perform the process steps described herein, hard-wired circuitry may be used in place of, or in combination with, software instructions for implementation of the processes of the present invention. Thus, embodiments of the present invention are not limited to any specific combination of hardware and software.

The program may also be implemented in programmable hardware devices such as field programmable gate arrays, programmable array logic, programmable logic devices or the like. Programs may also be implemented in software for execution by various types of computer processors. A program of executable code may, for instance, comprise one or more physical or logical blocks of computer instructions, which may, for instance, be organized as an object, procedure, process or function. Nevertheless, the executables of an identified program need not be physically located together, but may comprise separate instructions stored in different locations which, when joined logically together, comprise the program and achieve the stated purpose for the programs such as preserving privacy by executing the plurality of random operations. In an embodiment, an application of executable code may be a compilation of many instructions, and may even be distributed over several different code partitions or segments, among different programs, and across several devices.

The term “computer-readable medium” as used herein refers to any medium that provides or participates in providing instructions to at least one processor 16 of the dynamic anonymization system 10 (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, a RAM, a PROM, an EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to at least one processor for execution. For example, the instructions may initially be borne on a magnetic disk of a remote computer (not shown). The remote computer can load the instructions into its dynamic memory and send the instructions over an Ethernet connection, cable line, or telephone line using a modem. A communications device local to a computing device (e.g., a server) can receive the data on the respective communications line and place the data on a system bus for the at least one processor 16. The system bus carries the data to main memory, from which the at least one processor 16 retrieves and executes the instructions. The instructions received by main memory may optionally be stored in memory either before or after execution by the at least one processor 16. In addition, instructions may be received via a communication port as electrical, electromagnetic or optical signals, which are exemplary forms of wireless communications or data streams that carry various types of information.

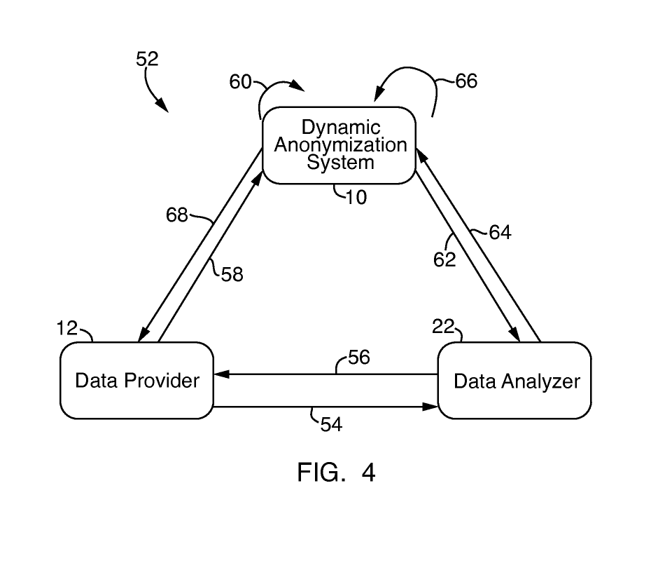

Referring to FIG. 4, an embodiment of a data analytics ecosystem 52 includes the dynamic anonymization system 10, data provider 12 and data analyzer 22. At 54, the data provider 12 sends a request to the data analyzer 22 requesting an analysis service. The request may include, for example, a description of available data for analysis and a description of the problem to be analyzed using the available data. At 56, the data analyzer 22 answers the request. The answer may include, for example, a description of the analysis to be performed and a request for specific information/data to be used in the analysis.

At 58, the data provider 12 transmits the dataset 11, shown in FIG. 1, to the dynamic anonymization system 10. The dataset 11, shown in FIG. 1, includes raw data for the analysis that satisfies the specific information/data request of the data analyzer 22 included with the answer. The data provider 12 may also include the analysis objective and/or the set of specific information to be hidden within the dataset 11, shown in FIG. 1, as discussed above. At 60, the dynamic anonymization system 10 anonymizes the dataset 11, shown in FIG. 1, according to the systems and methods described above, to provide the anonymized dataset 21, shown in FIG. 1.

At 62, the dynamic anonymization system 10 transmits the anonymized dataset 21, shown in FIG. 1, to the data analyzer 22. The data analyzer 22 performs its analysis on the anonymized dataset 21, shown in FIG. 1, and then transmits the analysis results back to the dynamic anonymization system 10 at 64. Since the data analyzer 22 is only able to operate on the anonymized dataset 21, shown in FIG. 1, any personal and/or sensitive data included in the initial dataset 11, shown in FIG. 1, remains hidden from the data analyzer 22.

At 66, the dynamic anonymization system 10 decodes the analysis results received from the data analyzer 22 using the decomposition parameter and information relating to the anonymization strategy applied to the plurality of subsets 34 when anonymizing the dataset 11, shown in FIG. 1, initially. The dynamic anonymization system 10 then transmits the decoded analysis results to the data provider 12 at 68. Thus, the data provider 12 is able to employ the data analyzer 22 to operate on and perform statistical analysis using its dataset 11, shown in FIG. 1, without compromising the privacy of sensitive information included in the dataset 11, shown in FIG. 1.

Although the dynamic anonymization system 10 has been described as being separate from the data provider 12, in embodiments, the dynamic anonymization system 10 may be incorporated as a component of the data provider 12 and may provide similar functionality to that discussed herein.

The dynamic anonymization system 10 advantageously provides for improved anonymization of datasets 11, shown in FIG. 1, by adding a dynamic component, such as a dynamic temporal component, to the anonymized datasets 21, shown in FIG. 1. This dynamic component may be particularly advantageous for anonymizing datasets represented as graphs where complex structures within the graphs make it more difficult to mask the entities within the graph and, therefore, make it easier for potential attackers to gain access to sensitive information within the datasets represented as graphs.

The dynamic anonymization system 10 advantageously adds the dynamic component to the anonymization process by dividing the initial dataset 11, shown in FIG. 1, into the plurality of subsets 34, shown in FIG. 2, which provides additional masking to sensitive data within the anonymized dataset 21, shown in FIG. 1. The dynamic anonymization system 10 also advantageously provides the anonymized datasets 21, shown in FIG. 1, by applying known anonymization strategies when individually anonymizing the subsets 34, shown in FIG. 2. The anonymized datasets 21, shown in FIG. 1, provided by the dynamic anonymization system 10 maintain high analytical quality while hiding sensitive information specified within the initial dataset 11, shown in FIG. 1.

The dynamic anonymization system 10 provides improved anonymization of datasets 11, shown in FIG. 1, through local, dynamic and temporal decomposition of the datasets 11. This improved anonymization results in more complex and robust anonymized datasets 21, shown in FIG. 1, that are more difficult for potential attackers to de-anonymize in attempts to learn sensitive information from the anonymized datasets 21, shown in FIG. 1.

Although this invention has been shown and described with respect to the detailed embodiments thereof, it will be understood by those skilled in the art that various changes in form and detail thereof may be made without departing from the spirit and the scope of the invention.

What is claimed is:

1. A dynamic anonymization system comprising:
at least one communication interface adapted to import at least one dataset into the dynamic anonymization system; and
at least one processor adapted to decompose the at least one dataset into a plurality of subsets, apply an anonymization strategy on each subset of the plurality of subsets, and aggregate the individually anonymized subsets to provide an anonymized dataset;
wherein the communication interface is adapted to output the anonymized dataset.

2. The dynamic anonymization system according to claim 1, further comprising:
a data decomposer executing on the at least one processor, the data decomposer adapted to divide the at least one dataset into the plurality of subsets;
a local anonymizer executing on the at least one processor, the local anonymizer adapted to apply the anonymization strategy on each subset of the plurality of subsets; and
an anonymization composer executing on the at least one processor, the anonymization composer adapted to aggregate the individually anonymized subsets to provide the anonymized dataset.

3. The dynamic anonymization system according to claim 2, additionally comprising a coordinator that ensures proper communication between the data decomposer, the local anonymizer and the anonymization composer.

4. The dynamic anonymization system according to claim 3, wherein the coordinator monitors operation of the decomposer, the local anonymizer and the anonymization composer to ensure that critical information is not released in the anonymized dataset.

5. The dynamic anonymization system according to claim 2, additionally comprising a feature processor adapted to input the at least one dataset and at least one analytical objective to provide values to objects in the dataset for the data decomposer.

6. The dynamic anonymization system according to claim 5, wherein the at least one dataset includes a set of information to be hidden; and
wherein the feature processor provides values for objects in the set of information to be hidden.

7. The dynamic anonymization system according to claim 1, wherein the communication interface includes a plurality of data loaders adapted to read datasets of different formats.

8. The dynamic anonymization system according to claim 1, wherein the communication interface includes a data server executing security protocol before outputting the anonymized dataset to ensure that the anonymized dataset is only accessed by authorized entities.

9. The dynamic anonymization system according to claim 1, wherein the communication interface is adapted to input analysis results based on the anonymized dataset;
wherein the at least one processor is adapted to decode the analysis results; and
wherein the communication interface is adapted to output the decoded analysis results.

10. A computerized method for providing an anonymized dataset, the computerized method comprising the steps of:
decomposing, at at least one processor, a dataset into a plurality of subsets;
individually anonymizing, at the at least one processor, each subset of the plurality of subsets; and
aggregating, at the at least one processor, the individually anonymized subsets to provide the anonymized dataset.

11. The computerized method according to claim 10, wherein decomposing, at the at least one processor, the dataset into the plurality of subsets includes dividing the dataset into the plurality of subsets based on a time dimension.

12. The computerized method according to claim 11, wherein each subset of the plurality of subsets is an independent interval that does not intersect other subsets of the plurality of subsets.

13. The computerized method according to claim 11, wherein at least one subset of the plurality of subsets is a cross interval that intersects another subset of the plurality of subsets.

14. The computerized method according to claim 10, additionally comprising:
providing, at the at least one processor, values to objects in the dataset based at least on an analytical objective before decomposing the dataset into the plurality of subsets.

15. The computerized method according to claim 14, wherein the values provided to the objects in the dataset are based on a set of information to be hidden.

16. A non-transitory, tangible computer-readable medium storing instructions adapted to be executed by a computer processor for providing an anonymized dataset by performing a method comprising the steps of:
decomposing, at at least one processor, the dataset into a plurality of subsets;
individually anonymizing, at the at least one processor, each subset of the plurality of subsets; and
aggregating, at the at least one processor, the individually anonymized subsets to provide the anonymized dataset.

17. The non-transitory, tangible computer-readable medium of claim 16, wherein decomposing, at the at least one processor, the dataset into the plurality of subsets includes dividing the dataset into the plurality of subsets based on a time dimension.

18. The non-transitory, tangible computer-readable medium of claim 17, wherein each subset of the plurality of subsets is an independent interval that does not intersect other subsets of the plurality of subsets.

19. The non-transitory, tangible computer-readable medium of claim 17, wherein at least one subset of the plurality of subsets is a cross interval that intersects another subset of the plurality of subsets.

20. The non-transitory, tangible computer-readable medium of claim 14, wherein the method additionally comprises:
providing, at the at least one processor, values to objects in the dataset based at least on an analytical objective before decomposing the dataset into the plurality of subsets.
